(19) United States
(12) Patent Application Publication
(10) Pub. No.: US 2014/0290036 A1
(43) Pub. Date: Oct. 2, 2014

(54) Tool that strips and twists or pigtails the ends of electrical wires in residential or commercial installations

(71) Applicant: Christopher Leonard Swenson, Dallas, TX (US)

(72) Inventor: Christopher Leonard Swenson, Dallas, TX (US)

(73) Assignee: Christopher Leonard Swenson, Dallas, TX (US)

(21) Appl. No.: 14/224,913

(22) Filed: Mar. 25, 2014

Related U.S. Application Data
(60) Provisional application No. 61/805,435, filed on Mar. 26, 2013.

(51) Int. Cl. H02G 1/12

(52) U.S. Cl. CPC H02G 1/1221
USPC 29/566.4

(57) ABSTRACT

A tool that strips and twists or “pigtails” the ends of electrical wires in residential or commercial installations is disclosed. The invention uses the rotation of a drill or driver to strip and twist the wires quickly and perfectly, not overtwisting, ensuring a sound connection and maximum mobility of the connection.

### BACKGROUND OF THE INVENTION

Problem Solved: When installing electrical outlets, light switches, etc. in a building, thick, rigid wires must often be stripped and twisted together to make connections. This requires two pliers to correctly twist wires together by hand and is difficult to do quickly and correctly such that a connection is sound due to space restraints in an electrical box or outlet, and the number and rigidity of wires, which are typically 12 AWG.

Electricians strip and twist wires by hand and cap them with “wire nuts” or simply insert wires, untwisted, into a wire nut and twist the nut. Connections may be loose and are difficult to perform by hand. It is also time consuming to twist the wires by hand.

The invention uses the rotation of a drill or driver to strip and twist the wires quickly and perfectly, not overtwisting, ensuring a sound connection and maximum mobility of the connection.

### DETAILED DESCRIPTION OF THE INVENTION

As stated above, when installing electrical outlets, light switches, etc. in a building, thick, rigid wires must often be stripped and twisted together to make connections. This requires two pliers to correctly twist wires together by hand and is difficult to do quickly and correctly such that a connection is sound due to space restraints in an electrical box or outlet, and the number and rigidity of wires. The invention claimed here solves this problem.

The invention connects to a drill or driver. It accepts wires into one end of the tool and rotates, automatically gripping, stripping, and twisting the wires.

The claimed invention differs from what currently exists. Wire twisting is largely done by hand.

This invention is an improvement on what currently exists. Simple manual tools exist for twisting wires but these are still cumbersome and inefficient. Several patents exist that recognize this problem and attempt to solve this problem. None offer an all in one, effective solution.

Connections done by hand may be loose, imperfect, twist too much wire so that it is difficult to move when installing the switch or outlet, etc.

The invention uses the rotation of a drill or driver to strip and twist the wires quickly and perfectly, not overtwisting, ensuring a sound connection and maximum mobility of the connection.

### THE VERSION OF THE INVENTION DISCUSSED HERE INCLUDES

12: Sleeve
14: Sleeve Cap
16: Sleeve Cap Clover Opening
18: Spindle Slug
20: Spindle Blades
22: Spindle Shaft
24: Wire Guide Holes
26: Return Spring
28: View Slots
30: Insulation Discharge Slots
36: Tool Clamp

Relationship Between the Components:

The 14. Sleeve Cap is screwed on to the 12. Sleeve after the 26. Return Spring and 18. Spindle Slug, 20. Spindle Blades, 22. Spindle Shaft, and 24. Wire Guide Holes (all one piece called the Spindle) are inserted into the 12. Sleeve. The 18. Spindle Slug, 20. Spindle Blades, 22. Spindle Shaft, and 24. Wire Guide Holes all rotate with respect to the driver drill and wires. The 12. Sleeve, 14. Sleeve Cap, and 16. Sleeve Cap Clover Opening are all fixed with respect to the driver drill and wires, held in place by hand or by using the 36. Tool Clamp, which connects the 12. Sleeve to the driver drill through a rigid arm and a strap. The special shaped opening, the 16. Sleeve Cap Clover Opening, is an opening on the end of the 14. Sleeve Cap. The 18. Spindle Slug is beveled so that the end of it sits in the central hole in the 16. Sleeve Cap Clover Opening. There are six half-holes around the outside of the central hole of the 16. Sleeve Cap Clover Opening. The 28, View Slots and 30. Insulation Discharge Slots are openings on the sides and end of the 12. Sleeve, respectively.

How The Invention Works:

The 18. Spindle Slug, 20, Spindle Blades, 22. Spindle Shaft, and 24, Wire Guide Holes all rotate with respect to the driver drill and wires. The 12. Sleeve, 14. Sleeve Cap, and 16. Sleeve Cap Clover Opening are all fixed with respect to the driver drill and wires, held in place by hand or by using the 36. Tool Clamp. The 18. Spindle Slug is a cylinder on the end of the 22. Spindle Shaft with six holes in it, the 24. Wire Guide Holes. Wires are inserted through the 16. Sleeve Cap Clover Opening, and so through the 14, Sleeve Cap, and into the 24. Wire Guide Holes located in the 18. Spindle Slug. As the 22. Spindle Shaft is rotated by the driver drill, the 18. Spindle Slug also rotates, twisting the wires. As the wires are twisted, due to their rigidity, they push the 12. Sleeve and the 14. Sleeve Cap forward, pulling the wires through the 24. Wire Guide Holes in the 18. Spindle Slug and across the 20. Spindle Blades, stripping the ends of the wires. When the 18. Spindle Slug initially rests in the 16. Sleeve Cap Clover Opening its six half-holes align with the 24. Wire Guide Holes. As the 18. Spindle Slug and therefore 24. Wire Guide Holes rotate, half of the outer circumference of the wires are fixed in place by the six half-holes of the 16. Sleeve Cap Clover Opening so that only the wire ends inside of the device are twisted and stripped. Any stripped insulation is ejected from the 30. Insulation Discharge Slots. When the stripped and twisted wire is removed the 26. Return Spring returns the device to its initial state.

How To Make The Invention:

Most components of this invention require machining or casting. The 14. Sleeve Cap and 12. Sleeve require thread machining on a lathe, and either casting, lathe, and/or drill press to create the 18. Spindle Slug, 20. Spindle Blades, 22. Spindle Shaft and 24. Wire Guide Holes. The 26. Return Spring is available commercially. The 16. Sleeve Cap Clover Opening, 28. View Slots, and 30. Insulation Discharge Slots may be created using an EDM (Electrical Discharge Machining) machine.

All elements are necessary to accomplish the multi-function of stripping and twisting wires. The 18. Spindle Slug and 16. Sleeve Cap Clover Opening may be modified to improve performance. Different Spindles may be made available to accommodate different wire sizes. The invention is designed to be dis-assemblable for replacing components.

How To Use The Invention:

While working on an electrical, outlet, gather the unstripped wires to be stripped and twisted into a group facing out of the outlet, making sure the wires are sufficient length to be inserted into the invention. Grasp the 12. Sleeve in one hand or affix the 12. Sleeve to the driver drill using the 36. Tool Clamp. Activate the driver drill to begin stripping/twisting of the wires while the 12. Sleeve is stationary. Operate the driver drill clockwise or forward, until wires are stripped and twisted.

Additionally: The invention could be used in automated assembly of wire harnesses in computer manufacturing, automobile manufacturing, or other manufacturing where it is desirable to strip and twist wires for assembly.

### DRAWING DESCRIPTION

FIG. 1: is a perspective view of the invention, shown in use

FIG. 2: is a perspective view of the invention, showing single handed use with optional tool clamp

FIG. 3: is a section view of the invention, taken along line 2-2 in FIG. 1

FIG. 4: is an exploded view of the invention

FIG. 5: is a section view of the invention, illustrating the insertion of wires into the sleeve and a frontal view of the clover cap

FIG. 6: is a section view of the invention, illustrating the wires fully inserted

FIG. 7: is a section view of the invention, illustrating the stripping and twisting actions

FIG. 8: is a section view of the invention, illustrating the removal of twisted wires

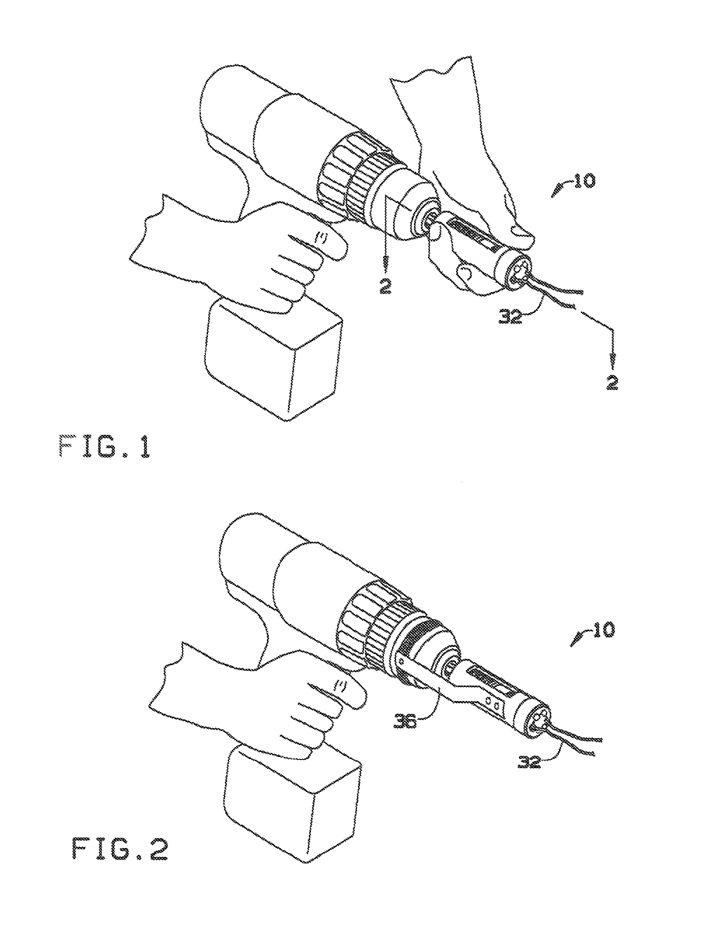

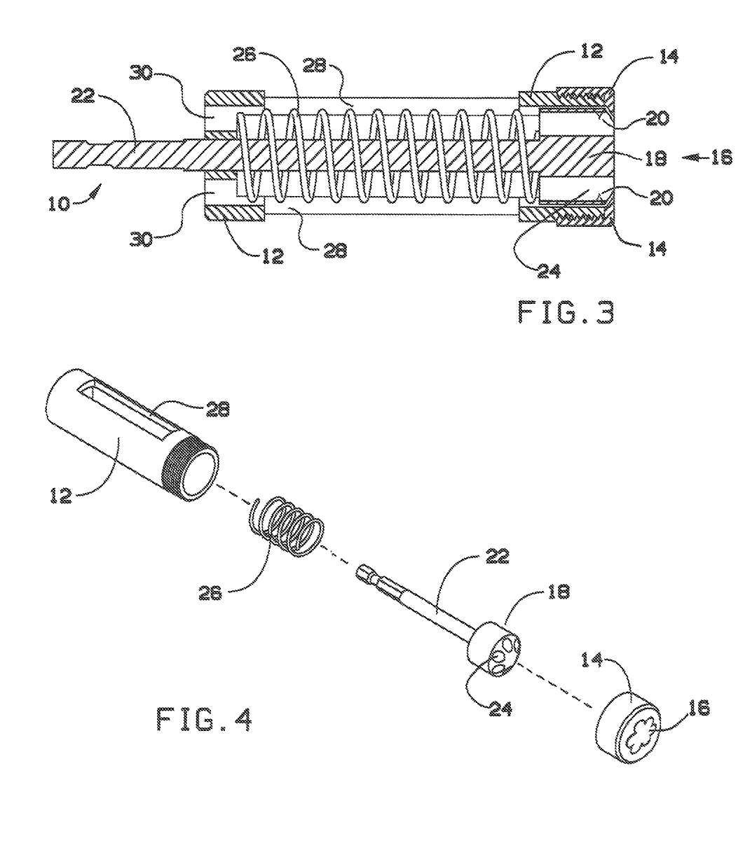

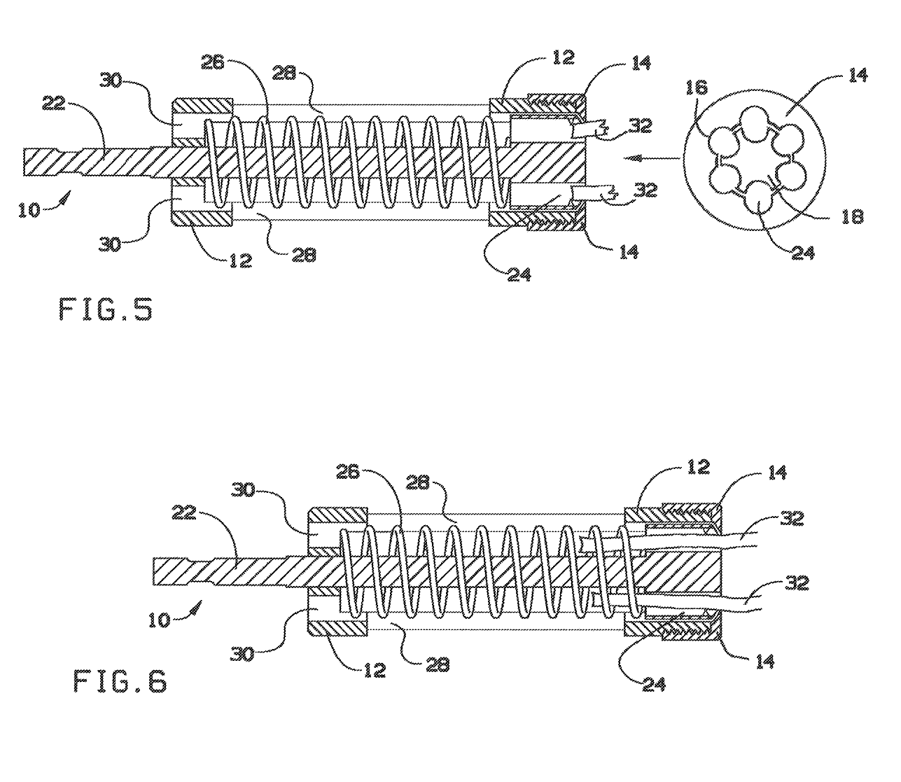

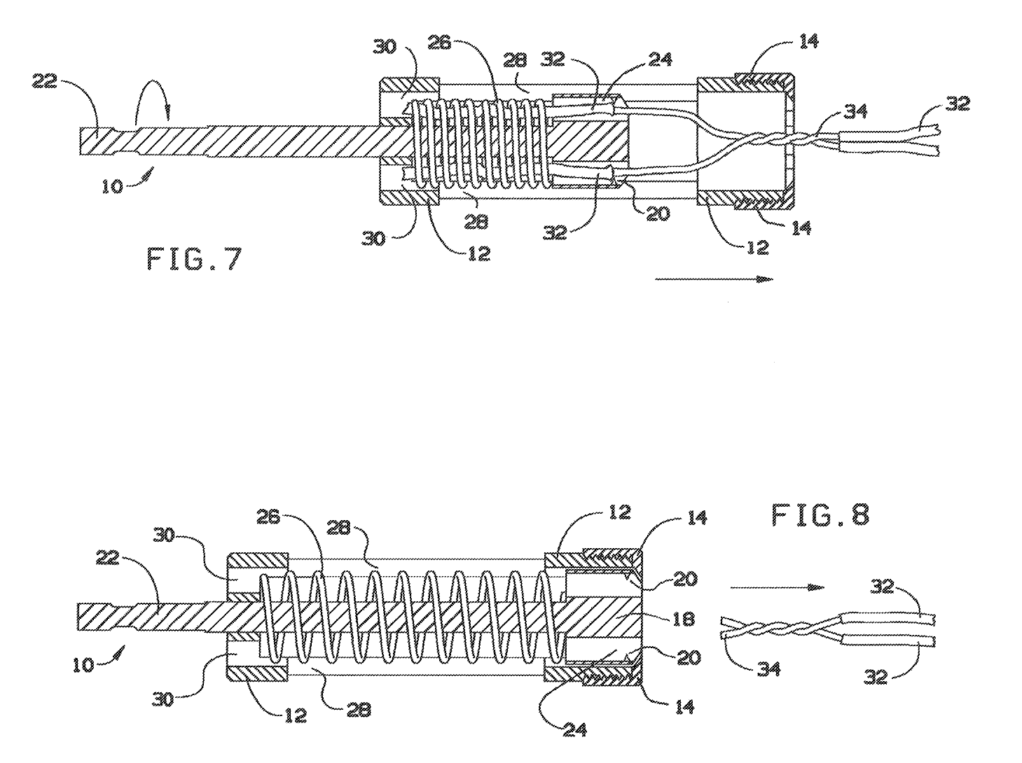

### DESCRIPTION LIST

10: is the wire pigtailer assembly
12: is the sleeve
14: is the sleeve cap
16: is the sleeve cop clover opening
18: is the spindle slug
20: are the spindle blades
22: is the spindle shaft
24: are the wire guide holes
26: is the return spring
28: are the view slots
30: are the insulation discharge slots
32: is the wire insulation
34: is the hare wire
36: is the tool clamp

What is claimed is:

1. Sleeve. A hollow cylindrical tool-grade steel tube with male threads on one open end and a closed end with an opening through which a Spindle Shaft fits.

2. Sleeve Cap. A tool-grade steel cap with female threads and a special opening consisting of a central interior edge-beveled circular opening surrounded at 60 degree angles by smaller half circumference holes that screws onto claim 1.

3. Sleeve Cap Clover Opening. A central interior edge-beveled circular opening surrounded at 60 degree angles by smaller half circumference holes, contained on the end of claim 2.

4. Spindle Slug, A tool-grade steel cylinder with a beveled end and six Wire Guide Holes that fits into claim 1.

5. Spindle Blades. Off-center wire stripping blades located in the Wire Guide Holes in claim 4.

6. Spindle Shaft. A tool-grade steel shaft with a standard driver drill adaptor end and the other end affixed to claim 4.

7. Wire Guide Holes. Six holes at 60 degrees apart through claim 4 and containing claim 5 that accept wire to be stripped and twisted.

8. Return Spring. A spring that is inserted between the closed end of claim 1 and claim 4.

9. View Slots. Slots cut lengthwise along claim 1.

10. Insulation Discharge Slots. Slots cut in the closed end of claim 1 that allow stripped wire insulation to be discharged from the invention.

11. Tool Clamp. A rigid arm and a strap which connects claim 1 to the driver drill.
